(19) United States
(12) Patent Application Publication
(10) Pub. No.: US 2007/0056430 A1
(43) Pub. Date: Mar. 15, 2007

(54) Musical instrument suspension system

(76) Inventor: Kenneth Albert Lee, Indian Springs, AL (US)

Correspondence Address: Kenneth A. Lee, 5101 Old Mill Court, Indian Springs, AL, 35124, US

(21) Appl. No.: 10/939,445

(22) Filed: Sep. 12, 2005

(51) Int. Cl. G10D 7/10

(52) U.S. Cl. 84/395

(57) ABSTRACT

A counterbalance assembly for attaching to an instrument to transfer the weight of an instrument from the player's hands, wrists, arms and shoulder joints to the large muscles across the top of the shoulders comprising a counterweight on one end of a shaft, the other end of which hinges at the center of balance of the instrument, where the assembly is attached to the instrument. Using the player's shoulder as the fulcrum, the assembly takes the weight of the instrument off the delicate structures of the hand and wrist, causing the instrument to “float” in front of the player. Not only does this redistribution of weight relieve the player's hands and arms of the force required to support the horn, the reduction in muscle tension allows the player greater control in the playing of the instrument.

### BACKGROUND OF THE INVENTION

Persons who play musical instruments must support the instrument with one hand and use their other to control and move the valves, keys or slides in order to change the tone of the output sounds which gives the instrument its distinctive characteristics. The player of the instrument must support the instrument entirely with one hand while actuating valves, keys or slides with the other hand. The support means for conventional instruments are normally located at a position that is relatively close to the face of the player, which means that during playing the arm that supports the instrument must be relatively sharply bent at the elbow. The fact that the instrument is supported relatively close in means that the arm that supports the instrument has relatively little leverage on the instrument and as a result is usually experienced that the instrument supporting arm will tire relatively rapidly. These conditions limit the time that an instrument player can comfortably play his or her instrument. Also, the instrument is usually supported in large part by the fingers and the thumb, and this can cause the wrist as well as the forearm to assume a bent or strained position with respect to the upper arm, and the fingers and thumb, as well as the arm, therefore, become uncomfortable. The fingers especially will be subject to increased fatigue.

The present invention includes a hinged coupling to attach the device to the instrument's balance point, an adjustable load bearing shaft, and a counterweight. Using the player's shoulder as the fulcrum, the device transfers the weight of the instrument from the player's hands, wrists, arms and shoulder joints to the large muscles across the top of the shoulder. This takes the weight of the instrument off the delicate structures of the hand and wrist, causing the instrument to “float” in front of the player. Not only does this redistribution of weight relieve the player's hands and arms of the force required to support the horn, the reduction in muscle tension allows the player greater control in the playing of the instrument.

The improvements are embodied in a counterweight attached to a shaft coupled to the center of balance of the instrument. With the subject improvements, the player also has the option of using the usual conventional support means if desired. It is expected that most instrument players, especially those who play for long periods at a time, will probably prefer to hold the instrument with the new suspension system since it will provide a more relaxed arm and will enable the instrument player to play without pain and for longer times without becoming physically tired. The system includes a clamp for attaching to the instrument. The assembly can be either permanently or removably attached as preferred and when used does not substantially change the appearance of the instrument.

It is a principal object of the present invention to provide improved means for supporting a musical instrument.

Another object is to make it possible for a player to play his instrument for longer periods of time and in a more relaxed and therapeutic position without need to rest the player's shoulder, elbow, wrist or fingers.

Another object is to provide relatively inexpensive means for attaching to an instrument to allow the player to grip and support the instrument while giving substantially the same “feel” as a conventional instrument.

Still another object is to provide at means for installing on an instrument which improves both the transverse and longitudinal balance while shifting the weight of the instrument to the large muscles of the shoulder, which are far more suited to such loads than the delicate bones and muscles of the hands and wrist, enabling the operator to support it with less effort.

Another object is to increase the enjoyment of playing instruments and without substantially changing the overall weight and appearance of the instrument or the conventionally taught methods of using the hand and fingers to support same.

These and other objects and advantages of the present invention will become apparent to those skilled in the art after considering the following detailed specification disclosing preferred embodiments of the invention in conjunction with the accompanying illustrations.

### SUMMARY OF THE INVENTION

Brass instruments such as the trumpet and trombone have gotten heavier throughout their evolution.

These instruments are now so heavy they can cause physical discomfort and injury for the player over an extended period of time.

These problems are made manifest as Carpal Tunnel Syndrome, muscle soreness, muscle cramping, wrist injuries, tennis elbow, rotator cuff injuries, pulled ligaments, misalignment of the spine and even broken finger or wrist bones.

The illustrated device, while showing its attachment to the trombone, is suitable for any instrument supported by the player away from the body.

The device consists of a hinged coupling to attach the device to the instrument's balance point, an adjustable load bearing shaft, and a weight.

Using the player's shoulder as the fulcrum, the device transfers the weight of the instrument from the player's hands, wrists, arms and shoulder joints to the large muscles across the top of the shoulder.

This takes the weight of the instrument off the delicate structures of the hand and wrist, causing the instrument to “float” in front of the player.

Not only does this redistribution of weight relieve the player's hands and arms of the force required to support the instrument, the reduction in muscle tension allows the player greater control in the playing of the instrument.

This device will allow the older player to play without pain and the younger player to play for extended periods without tension and fatigue.

### BRIEF DESCRIPTION OF THE DRAWING

FIG. 1 is a view of the subject improved suspension system shown in solid shape and in association with the trombone to which the suspension system is attached.

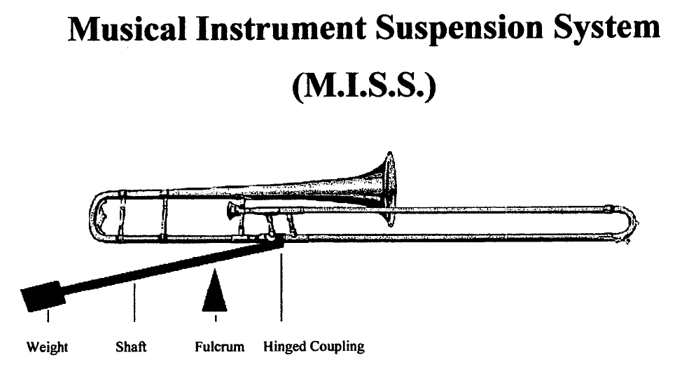

Thus, there has been shown and described a novel and utilitarian suspension system for attaching to an instrument in order to provide the player a better alternative for supporting the instrument during the playing thereof It will be apparent to those skilled in the art, however, that many changes, modifications, variations, uses and applications for the subject device are possible, and all such changes, modifications, variations, uses and applications which do not depart from the spirit and scope of the invention are deemed to be covered by the invention which is limited only by the claims which follow.

### DETAILED DESCRIPTION OF PREFERRED EMBODIMENTS

The drawing refers to a trombone having the present improvement mounted thereon. The instrument is played by a right handed person who stabilizes the instrument with his left hand and arm and operates the instrument with his right hand. The fulcrum consists of the muscles across the top of the player's left shoulder. The counterweight counterbalances the weight of the instrument, subjecting the muscles across the top of the player's left shoulder to the combined weight of the suspension system and the instrument.

What is claimed is:

1. A counterbalance assembly for mounting on an instrument to provide an alternative for the supporting hand of a player, comprising a counterweight, a shaft, a pivot joint and a means for attaching the members to the instrument, so that the hand supports none of the weight of the instrument.

2. The attachment assembly in accordance with claim 1 wherein said means for attaching the assembly members include split clamp assemblies formed of first and second clamp members, and means connecting the first and second clamp members.

3. The attachment assembly in accordance with claim 1 wherein said assembly members are fixedly attached to the center of balance on the instrument.
